(19) United States
(12) Patent Application Publication
(10) Pub. No.: US 2025/0347267 A1
(43) Pub. Date: Nov. 13, 2025

(54) YAW-BEARING GREASE TRAY

(71) Applicant: Inventus Holdings, LLC, Juno Beach, FL (US)

(72) Inventors: Mario PINEDA, JR., Hughson, CA (US); Todd M Thomas, Pleasanton, CA (US)

(21) Appl. No.: 19/204,755

(22) Filed: May 12, 2025

Related U.S. Application Data
(63) Continuation of application No. 18/961,606, filed on Nov. 27, 2024.
(60) Provisional application No. 63/645,831, filed on May 10, 2024.

(51) Int. Cl. F03D 80/70

(52) U.S. Cl. CPC F03D 80/709; F05B 2260/98

(57) ABSTRACT

A yaw-bearing grease tray for a wind turbine. The yaw-bearing grease tray includes an arcuate flat band portion with an inner arcuate sidewall, an outer arcuate sidewall, a first end wall and a second end wall which are perpendicular and disposed on the arcuate flat band portion. The yaw-bearing grease tray includes a ledge formed on the first end wall to be substantially parallel to the arcuate flat band portion and a step formed at the second end wall to be substantially parallel to the arcuate flat band portion. A plurality of magnets are disposed on the arcuate flat band portion to magnetically couple with yaw-bearing bolts and yaw-bearing nuts. In one example, the yaw-bearing grease tray is translucent. In another example, a field replaceable absorbent material is sized to fit within the arcuate flat band portion.

### CROSS-REFERENCE TO RELATED APPLICATIONS

This application claims priority from and is related to U.S. Provisional Application No. 63/645,831, entitled “Containment System With Drip Tray Segments Each Having Magnetic Fastener And Disposable Absorbent Pad” with attorney docket number AMMD-001-PROV, filed May 10, 2024 and U.S. application Ser. No. 18/961,606, entitled “Yaw-Bearing Grease Tray” with attorney docket number 104142/480-P0180, filed Nov. 27, 2024, each of these previously filed patent applications are commonly assigned herewith to Inventus Holdings, LLC, and hereby incorporated into the present application by reference in their entirety.

### FIELD OF THE DISCLOSURE

The present disclosure relates generally to wind turbines and, more particularly, to devices for collecting grease emitted from the yaw-bearings and yaw-ring of a wind turbine.

### BACKGROUND

The installation of wind turbines to generate electricity continues to grow. Wind turbines include several major components. The blades are aerodynamically designed to capture wind energy and convert it into rotational motion. These blades are connected to the rotor, which spins as the wind blows. The rotor is attached to a shaft, which transfers mechanical energy to the gearbox. The gearbox increases the rotational speed to a level suitable for the generator, which converts the mechanical energy into electrical energy. The generated electricity is then transferred through the nacelle, a housing unit that contains the gearbox, generator, and control systems, down the tower to a transformer, where it is prepared for distribution. The control system and yaw mechanism ensure the turbine is positioned optimally with respect to wind direction and speed for maximum efficiency. Lastly, foundations anchor the entire structure to the ground, providing stability.

A yaw bearing in a wind turbine is a crucial component that allows the nacelle, which houses the gearbox and generator, to rotate or “yaw” to face the wind. This rotation ensures that the turbine is always optimally aligned with the wind direction, maximizing energy capture. The yaw-bearing is positioned between the nacelle and the tower, facilitating smooth movement while supporting the weight of the nacelle and resisting various forces, such as wind loads and mechanical stress. It typically consists of large, durable metal rings with rollers or balls, allowing low-friction rotation and precise control by the yaw-drive system.

The yaw bearing is subject to significant mechanical stress and environmental exposure, necessitating regular maintenance to ensure smooth operation. Grease is commonly used to lubricate the yaw bearing, reducing friction and wear. However, improper greasing or worn seals can lead to excess grease splattering inside the tower, causing environmental and operational concerns. This grease can coat critical components, leading to performance issues and increased maintenance requirements. Additionally, it poses safety risks for maintenance personnel due to slippery surfaces.

### SUMMARY OF THE INVENTION

Disclosed is a novel yaw-bearing grease tray for a wind turbine. The yaw-bearing grease tray includes an arcuate flat band portion with an inner arcuate sidewall, an outer arcuate sidewall, a first end wall and a second end wall which are perpendicular and disposed on the arcuate flat band portion. The yaw-bearing grease tray includes a ledge formed on the first end wall to be substantially parallel to the arcuate flat band portion and a step formed at the second side wall to be substantially parallel to the arcuate flat band portion. The yaw-bearing grease tray includes a plurality of magnets disposed on the arcuate flat band portion to magnetically couple with yaw-bearing bolts and yaw-bearing nuts.

One or more portions of the yaw-bearing grease tray may be formed from translucent material in separate components joined together using glue, adhesive, ultra-sonic welding or a combination of techniques. In another example, the yaw-bearing grease tray may be formed as one unified piece using additive manufacturing or injection molding. In another example, the

An optional removable arcuate-shaped absorbent material may be sized to fit within the arcuate flat band portion to capture grease.

In another embodiment, the grease tray or drip tray includes an absorbent pad retaining portion and a magnetic fastener. In some embodiments, the apparatus further comprises a base, with the absorbent pad retaining portion formed as part of the base, and the magnetic fastener attached to the base. The apparatus may include structural features such as a first wall and a second wall opposite each other, and a third wall and a fourth wall also opposite each other. The first and second walls may extend non-linearly-such as curving radially-between the third and fourth walls, which may extend linearly and include features like a slanted portion. The wall heights may also vary, with the first wall being taller than the second.

The magnetic fastener may be one of several such fasteners distributed adjacent to the absorbent pad retaining portion, configured to align with and attach to bolt nuts or bolt ends or heads of a bearing system. The apparatus is described as a drip tray that may be assembled with other similar trays to form a containment system of a predetermined shape, such as circular, oval, triangular, rectangular, pentagonal, hexagonal, or other polygonal forms. The trays may be formed from a high impact polycarbonate material.

A method of use includes attaching the drip tray to a structure, such as a yaw bearing of a wind turbine, via the magnetic fastener, and inserting an absorbent pad into the retaining portion. The absorbent pad can be removed and replaced without detaching the drip tray from the structure, particularly when the pad is saturated. The method may also include attaching additional drip trays to form a modular containment system. The drip tray structure may include various wall configurations and dimensional differences, such as curvature and slanted or elevated sections, to suit installation needs.

In another aspect, the apparatus includes an absorbent pad retaining portion and means for attaching the apparatus to a structure without mechanical fasteners or altering the structure-such as using magnets. The magnetic means may be attached to a base that also includes the absorbent pad retaining portion.

The system also includes a drip tray system for capturing grease in wind turbines. It consists of a plurality of segmented, radial-shaped drip trays, each having a concave base with raised peripheral edges and fasteners (preferably magnetic) positioned along the base centerline. These fasteners align with bolt heads or similar features on the wind turbine. Each tray is fitted with a pre-cut absorbent pad made of fiber material, ensuring proper alignment and easy replacement. The trays are configured to be easily removed for inspection and maintenance. The absorbent pads are pre-packaged, often in sealed bags, and may include part numbers for simplified inventory and ordering.

A related method involves providing the segmented drip trays, attaching them magnetically to the turbine structure, placing the pre-cut absorbent pads inside each tray, and removing and replacing the pads when saturated. The system may segment into eight tray sections, each about three feet in length, forming a circular or radial pattern around the turbine structure. A wind turbine maintenance system integrates these features with part-numbered packaging to support logistics, replacement, and serviceability. A packaged containment system may also be provided, comprising multiple drip trays with absorbent pad retaining portions and magnetic fasteners, along with multiple absorbent pads. Additionally, a packaged absorbent pad product may feature pads with at least two sides extending non-linearly for better fit and retention.

Other features and advantages of the invention will become apparent to those skilled in the art upon review of the following detailed description, claims, and drawings.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is an example of a wind turbine deployed as part of a wind farm for electricity generation, according to the prior art;

FIG. 2 is an interior view of the nacelle of FIG. 1, illustrating the yaw-drive mechanism according to the prior art;

FIG. 3 is an enlarged interior view of FIG. 2, illustrating the major components of the yaw-drive mechanism according to the prior art;

FIG. 4 is an image of the interior of a tower under the yaw-bearing with lubricant dripping down the interior walls, according to the prior art;

FIG. 5 is a perspective view of the yaw-bearing grease tray, according to a first example of the present invention;

FIG. 6 is a cross-sectional view of the yaw-bearing grease tray of FIG. 5 taken along A-A′, according to a first example of the present invention;

FIG. 7 is a bottom view of the yaw-bearing grease tray of FIG. 5, according to a first example of the present invention;

FIG. 8 is a series of three yaw-bearing grease trays illustrating complementary interlocking ends, according to a first example of the present invention;

FIG. 9 is an arcuate-shaped absorbent material sized to fit within the arcuate flat band portion of FIG. 5 that captures the grease, according to a first example of the present invention;

FIG. 10 is a bottom view of a yaw-bearing grease tray with absorbent material magnetically coupled to the yaw-bearing nut and yaw-bearing bolt, according to a first example of the present invention;

FIG. 11 is a side view of the yaw-bearing grease tray with absorbent material magnetically coupled to the yaw-bearing nut and the yaw-bearing bolt of FIG. 10, according to a first example of the present invention;

FIG. 12 is another side view of the yaw-bearing grease tray with absorbent material magnetically coupled to the yaw-bearing nut and yaw-bearing bolt of FIG. 10, according to a first example of the present invention;

FIG. 13 is a bottom view of a series of three yaw-bearing grease trays illustrating complementary interlocking ends with absorbent material magnetically coupled to the yaw-bearing bolt and yaw-bearing nut, according to a first example of the present invention;

FIG. 14 is a perspective view of a grease tray or drip tray, according to a second example of the present invention;

FIG. 15 is a perspective view of the drip tray with absorbent pad, according to a second example of the present invention;

FIG. 16 is a top-down view of the drip tray, according to a second example of the present invention;

FIG. 17 is a top-down view of a complete containment system formed by arranging drip trays together, according to a second example of the present invention;

FIG. 18 is a method for installing and using a containment system, according to a second example of the present invention;

FIG. 19 is a perspective view of a containment system installed within a wind turbine structure, according to a second example of the present invention;

FIG. 20 is a diagram showing how material is captured along tray drip segments of the containment system, according to a second example of the present invention;

FIG. 21 is a flowchart of a method for forming and packaging a containment system, according to a second example of the present invention;

FIG. 22 is a diagram of a packaged containment system, according to a second example of the present invention;

FIG. 23 is a flowchart of a method for forming and packaging absorbent pads for a drip tray system, according to a second example of the present invention; and

FIG. 24 is a diagram of a packaged absorbent pad system, according to a second example of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

The terms “a” or “an”, as used herein, are defined as one or more than one. The term plurality, as used herein, is defined as two or more than two.

The term “absorbent material” and “absorbent pad” means any material that soaks up oils including sponges, cotton wool, cellulose-based products, and synthetic or organic Polymers, such as: polypropylene, polyurethane, polystyrene, epoxy, calcium carbonate, magnesium carbonate, peat moss, and polypropylene.

The term “adapted to” describes the hardware, software, or a combination of hardware and software that is capable of, able to accommodate, to make, or that is suitable to carry out a given function.

The term “another”, as used herein, is defined as at least a second or more.

The term “configured to” describes hardware, software or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “grease” is a solid or semisolid lubricant. Examples of grease are lubricants formed as a dispersion of thickening agents in a liquid lubricant. Grease generally consists of a soap emulsified with mineral or vegetable oil.

The terms “including” and “having,” as used herein, are defined as comprising (i.e., open language).

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

### Overview of Major Wind Turbine Components

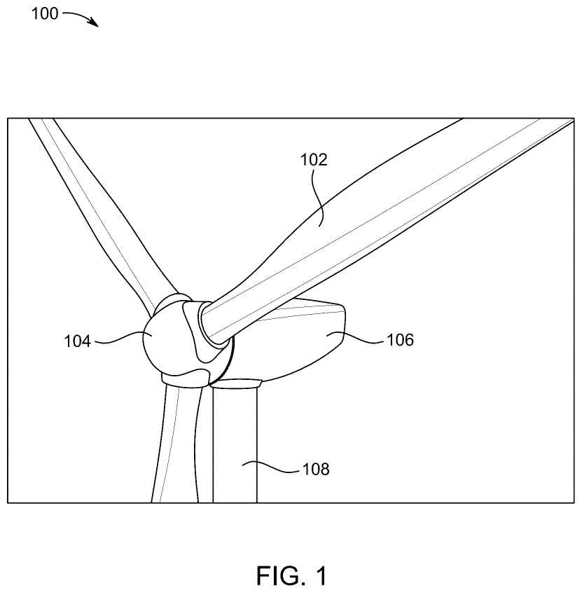

Turning to FIG. 1 is an example of a wind turbine 100 deployed as part of a wind farm for electricity generation. The blades 102 are aerodynamically designed to capture wind energy and convert it into rotational motion. These blades are connected to the rotor 104, which spins as the wind blows. The rotor is attached to a shaft, which transfers mechanical energy to the gearbox internal to the nacelle 106. The gearbox increases the rotational speed to a level suitable for the generator, which converts the mechanical energy into electrical energy. The generated electricity is then transferred through the nacelle 106, a housing unit that contains the gearbox, generator, and control systems, down tower 108 to a transformer, where it is prepared for distribution. The control system and yaw mechanism ensure the turbine is positioned optimally with respect to wind direction and speed for maximum efficiency.

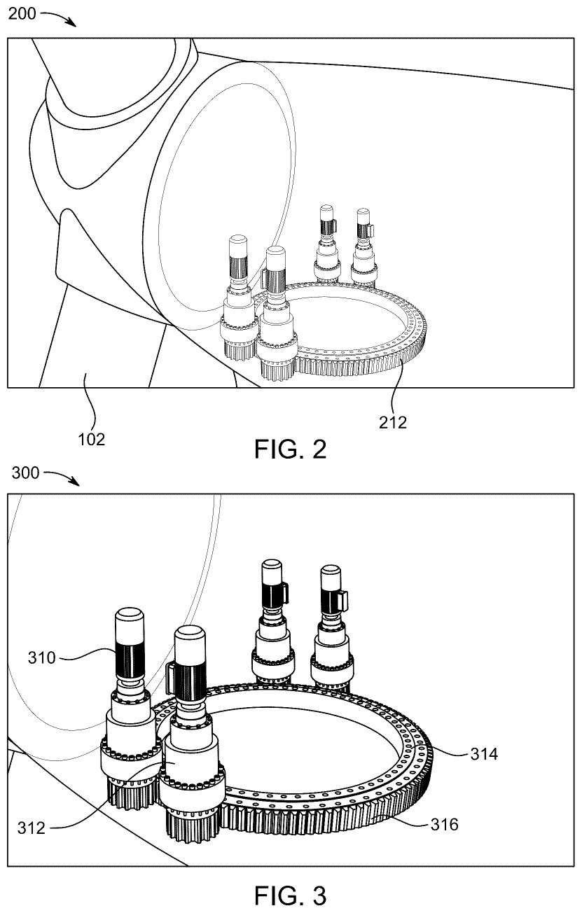

FIG. 2 is an interior view 200 of the nacelle of FIG. 1, illustrating the yaw-drive mechanism 212. The major components 300 of the yaw-drive mechanism are shown in FIG. 3. The major components include yaw-motor 310, yaw-motor with gearbox 312, yaw-bearing 314, and yaw-gear 316.

### Yaw-Bearing Grease Practices and Issues

Greasing the yaw-bearing of a wind turbine is a critical maintenance task that ensures smooth operation and extends the bearing's lifespan. The yaw-bearing enables the turbine to rotate, or “yaw,” to face the wind, maximizing energy capture. Over time, constant movement and exposure to harsh environmental conditions can lead to significant friction and wear on the bearing. Regular greasing minimizes this wear, reduces friction, and helps prevent corrosion, allowing the turbine to rotate efficiently without placing undue stress on its components. Proper lubrication ensures the yaw system operates smoothly, thus enhancing the turbine's overall performance.

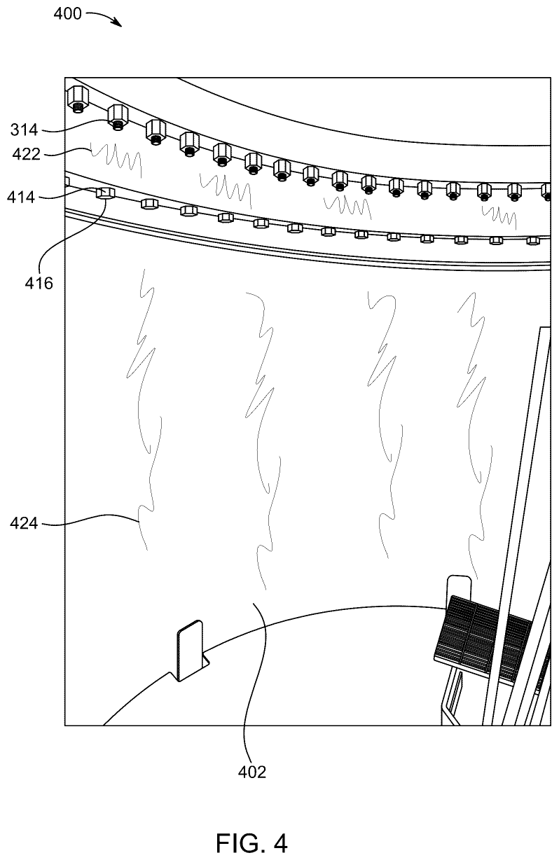

However, improper greasing practices or worn seals can cause excess grease to splatter onto the yaw deck and down the tower walls during operation. This issue is particularly common in warmer months when higher ambient temperatures cause the grease to liquefy. FIG. 4 is an image 400 of the interior wall 402 of the tower 108 with the yaw-bearing 314 and grease splatter or lubricant splatter 422, 424 dripping down the interior walls 402.

Also shown is a yaw-bearing nut 414 fastened to a yaw-bearing bolt 416, which involves threading the nut onto the bolt's threaded shaft to secure the yaw-bearing 314. The yaw-bearing bolt 416 has external threads that match the internal threads of the yaw-bearing nut 414, allowing them to interlock as the yaw-bearing nut 414 turns. For added security, components like lock washers or thread-locking compounds may be used to keep the nut and bolt firmly fastened under vibration or stress.

Grease splatter 422, 424 inside the tower 108 can coat critical components like electrical systems, sensors, and mechanical parts, leading to performance issues and increased maintenance requirements. In addition, it poses safety risks for maintenance personnel, as greasy surfaces can become slippery and difficult to clean. Over time, grease accumulation can contaminate other systems within the wind turbine 100, potentially causing malfunctions, especially if it reaches electrical connections or sensitive instrumentation.

### First Example of Yaw-Bearing Grease Tray

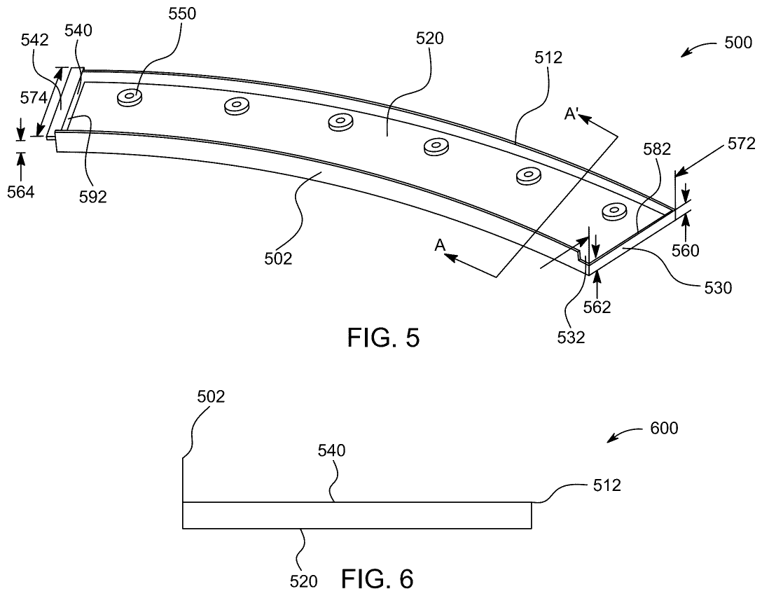

FIG. 5 illustrates a perspective view of a yaw-bearing grease tray 500 that prevents grease from splattering inside the tower 108. The yaw-bearing grease tray 500 is arcuate shaped, as shown. The yaw-bearing grease tray 500 has an inner sidewall 502 and an outer sidewall 512 separated by an arcuate flat band portion 520, wherein the height of the inner sidewall 502 is higher than the height of the outer sidewall 512. A plurality of magnets 550 is shown formed in an arcuate pattern in the arcuate flat band portion 520. In one example, the plurality of magnets 550 is substantially evenly spaced within the arcuate flat band portion 520, as shown. The magnets 550 are positioned and spaced apart to magnetically couple with the yaw-bearing-nut 414 and yaw-bearing bolt 416 of FIG. 4. The magnets can be any type of permanent magnet. Examples of permanent magnets include rare earth magnets such as samarium-cobalt and neodymium magnets.

The yaw-bearing grease tray 500 includes a first-end 530 with a first end wall 582 with a step 532. The step 532 is formed with a cutout or notch in the inner sidewall 502. The height 562 of the step 532 is approximately the same as the height 560 of the outer sidewall 560 at the first-end 530.

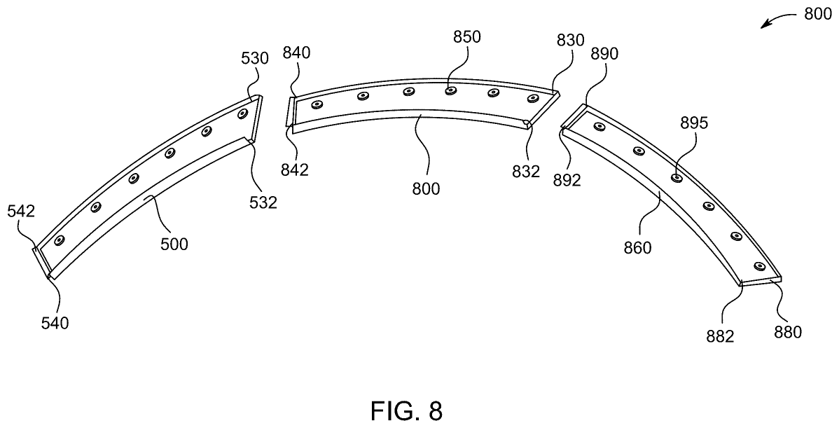

The yaw-bearing grease tray includes a second-end 540 with a second end wall 592 with a ledge 542. The ledge 542 is located on top of the second end wall 592 and is generally rectangular in shape, protruding out from the second-end 540. The ledge 542 is formed with a width 574 that fits inside the width 572 within the first end wall 582, as shown. The ledge 542 is disposed in-between and perpendicular to the inner sidewall 502 running along the second end 540 to the outer sidewall 512 at a height 564 that is approximately at the height 560 of the top of the outer sidewall 512 and the height 562 of the step 532. As further described below with reference to FIG. 8, the ledge 542 of a first yaw-bearing grease tray forms complementary interlocking ends when mechanically coupled with step 532 of a second yaw-bearing grease tray.

FIG. 6 is a cross-sectional view 600 of the yaw-bearing grease tray of FIG. 5 taken along A-A′. In this cross-sectional view, the yaw-bearing grease tray 500 is formed by the inner sidewall 502 and an outer sidewall 512 separated by an arcuate flat band portion 520 and second-end 540 in view.

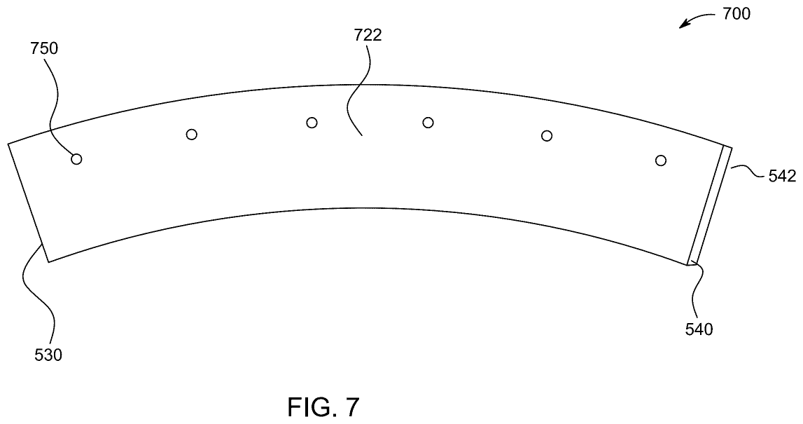

FIG. 7 is a bottom view 700 of the yaw-bearing grease tray of FIG. 5. The bottom 722 of the arcuate flat band portion 520 and a bottom 750 of the plurality of magnets 550 are shown along with the first-end 530 and the second-end 540. The ledge 542 is also visible from this bottom view.

### First Example of Interlocking Multiple Yaw-Bearing Grease Trays

FIG. 8 is a series of three yaw-bearing grease trays 500, 800, 860, illustrating complementary interlocking ends. More specifically, a second yaw-bearing grease tray 800 includes a first-end 830 with a step 832 and a second-end 840 with a ledge 842. Also shown is a plurality of magnets 850. The ledge 842 of the second yaw-bearing grease tray 800, when mechanically coupled with step 532 of the first yaw-bearing grease tray 500, forms complementary interlocking ends. Also shown is the third yaw-bearing grease tray 860, which includes a first-end 880 with a step 882 and a second-end 890 with a ledge 892. Also shown is a plurality of magnets 895. The step 832 of the second yaw-bearing grease tray 800, when mechanically coupled with ledge 892 of the third yaw-bearing grease tray 860, forms complementary interlocking ends.

### First Example of Optional Field-Replaceable Absorbent Material

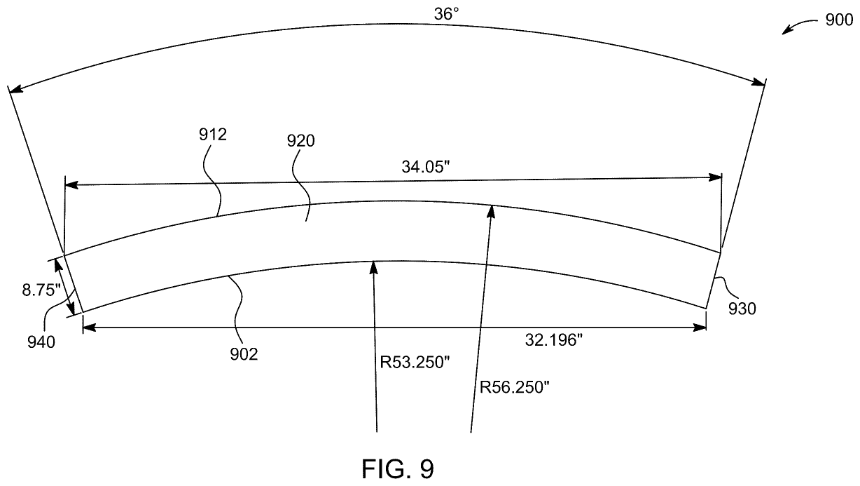

FIG. 9 is an arcuate-shaped absorbent material 900 sized to fit within the arcuate flat band portion 520 of FIG. 5. The placement of the absorbent material 900 in the arcuate flat band portion 520 is further described and shown in FIG. 11.

The arcuate-shaped absorbent material absorbs or captures the grease. One example is oil absorbent mats available from New Pig Corporation, which are cut to a desired shape. The arcuate-shaped absorbent material 900 is disposable. As described below, the arcuate-shaped absorbent material 900 may be replaced by magnetically decoupling an installed yaw-bearing grease tray and physically removing the arcuate-shaped absorbent material 900 from the arcuate flat band portion 520 of the tray. No tools are required.

In one example, the arcuate-shaped absorbent material 900 may be approximately 36 inches long with a width smaller than a width of approximately 8.75 inches of the arcuate-flat band portion 520. The actuate shape may be formed with a bottom linear measurement of 32.196 inches with a 53.250 inch radius and a top linear measurement of 34.05 inches with a 56.250 inch radius, as shown.

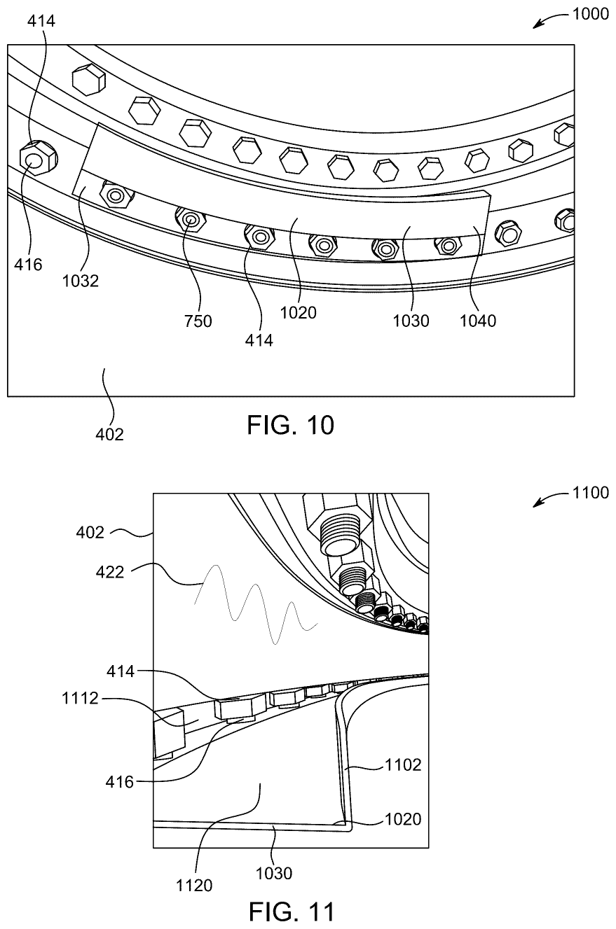

One example of the arcuate-shaped absorbent material 900 as used in an installed yaw-bearing grease tray is shown below in FIG. 10 and FIG. 11. In this example, the width of the arcuate-shaped absorbent material 900 is approximately half as wide as the arcuate-flat band portion 520 and is generally disposed near the inner sidewall 502, as shown. In this example, covering only half the width of the actuate-flat band portion 520 reduces any potential inference in the magnetic coupling between the magnets 550 and the yaw-bearing nut 414.

### First Example Yaw-Bearing Grease Tray Installations

FIG. 10 is a bottom view 1000 of a yaw-bearing grease tray 1020 as installed. More specifically shown is the bottom side 1030 of the yaw-bearing grease tray 1020 with absorbent material 1040 covering a portion of the arcuate flat band portion of the yaw-bearing grease tray 1020. The other portion 1032 of the arcuate flat band portion of the yaw-bearing grease tray is depicted as translucent, with the bottom of magnets 750 in view. The magnets 750 are positioned along the yaw-bearing grease tray 1020 to magnetically attach to the yaw-bearing nut 414 and the yaw-bearing bolt 416.

FIG. 11 is a side view 1100 of a yaw-bearing grease tray 1020 as installed. The yaw-bearing grease tray 1020 is magnetically coupled to the yaw-bearing nut 414 and the yaw-bearing bolt 416 of FIG. 10. Also shown is the bottom side 1030 of the yaw-bearing grease tray 1020 with absorbent material 1120 covering a portion of the arcuate flat band portion of the yaw-bearing grease tray 1020. The yaw-bearing grease tray 1020 has the inner sidewall 1102 and an outer sidewall 1112 separated by an arcuate flat band portion 1020.

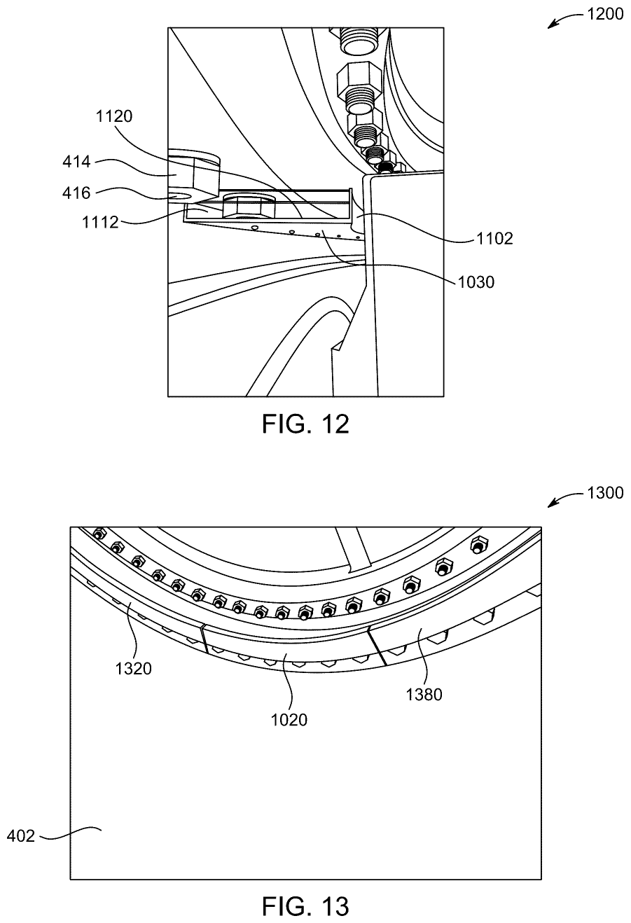

FIG. 12 is another side view 1200 of a yaw-bearing grease tray 1020 magnetically coupled to the yaw-bearing nut 414 and the yaw-bearing bolt 416 of FIG. 10. The yaw-bearing grease tray 1200 has the inner sidewall 1102 and an outer sidewall 1112 separated by an arcuate flat band portion 1020.

FIG. 13 is a bottom view 1300 of a series of three yaw-bearing grease trays 1020, 1320, 1380, illustrating complementary interlocking ends of FIG. 10.

### First Example of Fabrication of Yaw-Bearing Grease Tray

In one example, the yaw-bearing grease tray 500 can be fabricated as one part using injection molding techniques or additive manufacturing such as 3-D printing. In another example, the yaw-bearing grease tray may be fabricated in individual parts. These individual parts may include one or more of the inner sidewall 502, the outer sidewall 512, and the arcuate flat band portion 520. These individual parts may be fastened together using adhesive, glue, or ultrasonically welded. The yaw-bearing grease tray may be formed as translucent so that technicians can view grease accumulation on the absorbent material from the yaw-bearing gears.

### Second Example of Yaw Bearing Grease Tray

In the description and claims, terms such as “top”, “bottom”, “front”, “back”, and “side” are used to describe relative directions and orientations between different parts of a novel drip tray and containment system, and it is to be understood that the overall structure being described can actually be oriented in any way in three-dimensional space.

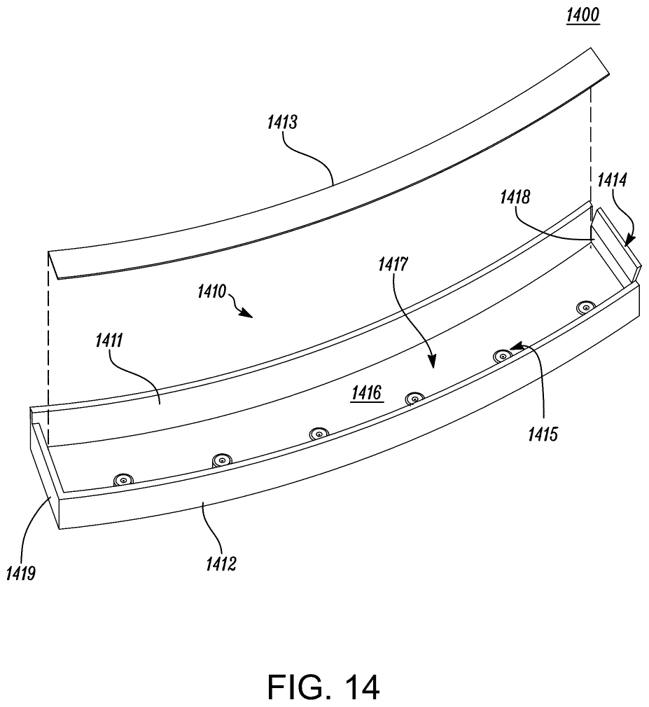

FIG. 14 is a diagram 1400 showing a perspective view of a grease tray or drip tray 1410. The drip tray 1410 includes a base 1416 that forms the foundational support of the drip tray 1410. Extending upward from the base 1416 are a first wall 1411 and a second wall 1412. An absorbent pad retaining portion 1417 located on the base 1416 supports an absorbent pad 1413. In one embodiment, the absorbent pad retaining portion 1417 is indented into or otherwise visually indicated on the base 1416. A slanted portion 1414 is part of a third wall 1418, which, along with a fourth wall 1419, defines the perimeter of the drip tray 1410. Magnetic fasteners 1415 are attached to the base 1416 and are distributed along the length of the drip tray 1410 to facilitate attachment to a structure.

In one embodiment, each magnetic fastener 1415 is attached to base 1416 with a bolt, a screw, an adhesive, a press-fit, or any other suitable attachment mechanism. In another embodiment, magnetic fastener 1415 is manufactured with an additive manufacturing process, for example, each magnetic fastener 1415 is 3D printed into the base 1416.

In some aspects, the drip tray 1410 could be made from a different type of plastic or even metal, provided it retains the desired properties such as impact resistance and potential flame retardancy. In other embodiments, the absorbent pad 1413 could be made from a different type of absorbent fiber or even a sponge-like material, provided it retains the desired properties such as grease absorption and ease of replacement.

In various embodiments, the design of the drip tray 1410 could be altered to better fit different tower designs or to capture grease more efficiently. The size of the drip tray could also be adjusted, either to make it larger and capture more grease or to make it smaller and easier to install and maintain.

In other embodiments, the magnetic fasteners 1415 could be replaced with a different type of fastening system. For instance, a mechanical fastening system such as clips or hooks could be used, or an adhesive fastening system could be used. The fastening system could also be designed to be adjustable, allowing the drip tray to be moved or repositioned as desired.

In various embodiments, the design of the absorbent pad 1413 could be varied in several ways. For instance, the shape of the pad could be altered to better fit the drip tray or to absorb grease more efficiently. The size of the pad could also be adjusted, either to make it larger and absorb more grease or to make it smaller and easier to replace.

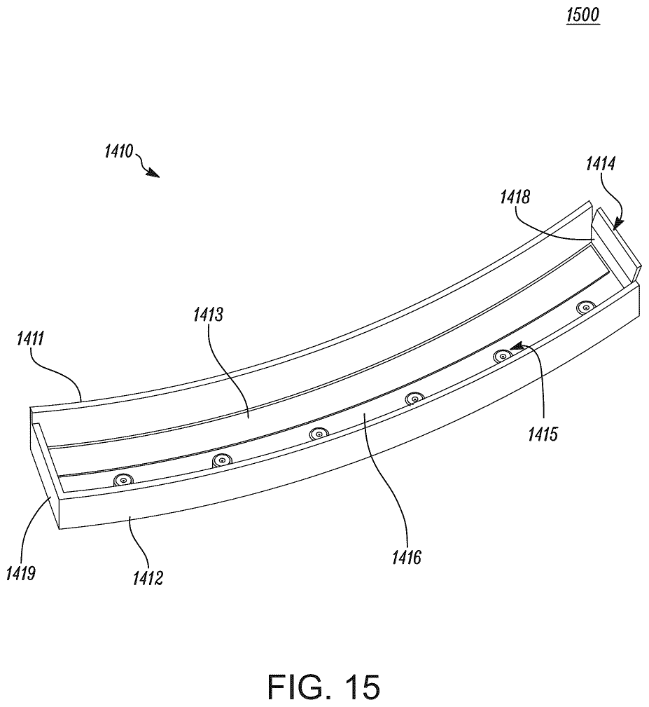

FIG. 15 is a diagram 1500 showing a perspective view of the drip tray 1410 with absorbent pad 1413. The base 1416 provides foundation support of the drip tray 1410, with an absorbent pad 1413 supported by the base 1416. The first wall 1411 and the second wall 1412 extend along the longer edges of the base 1416, while the third wall 1418 and the fourth wall 1419 rise from the shorter ends of the base 1416. The slanted portion 1414 is part of the third wall 1418, angling downward towards the base 1416. This slanted portion 1414 can help direct the grease towards the absorbent pad 1413, enhancing the efficiency of grease capture. Magnetic fasteners 1415 are strategically placed along the edges of the base 1416, designed to secure the drip tray 1410 to a corresponding structure. In other embodiments, the magnetic fasteners 1415 could be placed in different locations on the base 1416, depending on the specific requirements of the structure to which the drip tray 1410 is to be attached.

In various embodiments, the drip tray 1410 could be designed to have a different shape or size to better fit different tower designs or to capture grease more efficiently. For instance, the drip tray 1410 could be designed to have a rectangular, oval, or polygonal shape, depending on the shape of the structure to which it is to be attached. The size of the drip tray 1410 could also be adjusted, either to make it larger and capture more grease or to make it smaller and easier to install and maintain.

In some embodiments, the absorbent pad 1413 could be made from a different type of absorbent fiber or even a sponge-like material, provided it retains the desired properties such as grease absorption and ease of replacement. The absorbent pad 1413 could also be designed to have a different shape or size to better fit the drip tray 1410 or to absorb grease more efficiently. For instance, the absorbent pad 1413 could be designed to have a rectangular, oval, or polygonal shape, depending on the shape of the drip tray 1410. The size of the absorbent pad 1413 could also be adjusted, either to make it larger and absorb more grease or to make it smaller and easier to replace.

In other embodiments, the magnetic fasteners 1415 could be replaced with a different type of fastening system. For instance, a mechanical fastening system, such as clips or hooks, could be used, or an adhesive fastening system could be used. The fastening system could also be designed to be adjustable, allowing the drip tray 1410 to be moved or repositioned as desired.

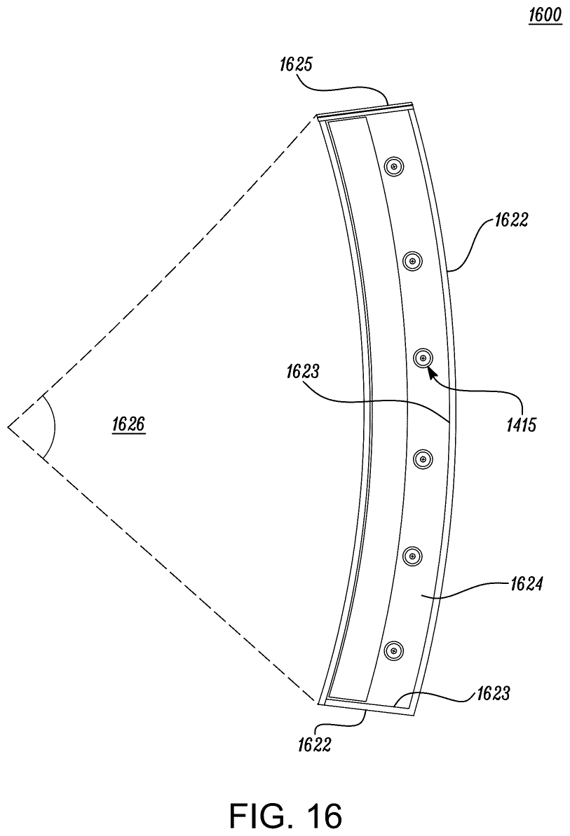

FIG. 16 is a diagram 1600 showing a top-down view of the drip tray 1410. The drip tray 1410 includes an outer wall edge 1622 and an inner wall edge 1623, which define the boundaries of the tray. Magnetic fasteners 1415 are situated along the inner wall edge 1623, providing a means for attaching the tray to a structure. The inner tray base 1624 forms the bottom surface of the tray, where an absorbent pad would be placed. A slanted upper edge 1625 is shown at the top of the figure, which in some aspects, could help prevent grease from spilling over the edge. For example, grease that falls onto the slanted upper edge 1625 would fall into the tray and not between any gap formed by two adjacent trays. A predetermined angle 1626 is identified. The predetermined angle 1626 is selected based on the shape and configuration of the overall containment system.

In other embodiments, the magnetic fasteners 1415 could be positioned at different locations along the inner wall edge 1623, depending on the specific requirements of the structure to which the drip tray is to be attached. The magnetic fasteners 1415 could also be designed to have a different strength or size to ensure secure attachment of the drip tray to the structure.

In some aspects, the inner tray base 1624 could be designed to have a different shape or size to better fit the absorbent pad or to optimize the collection of grease. The inner tray base 1624 could also be made from a different material, provided it retains the desired properties such as grease resistance and durability.

In other embodiments, the outer wall edge 1622 and the inner wall edge 1623 could be designed to have different shapes or sizes to better fit the structure to which the drip tray is to be attached or to optimize the containment of grease within the tray. The outer wall edge 1622 and the inner wall edge 1623 could also be made from different materials, provided they retain the desired properties such as grease resistance and durability.

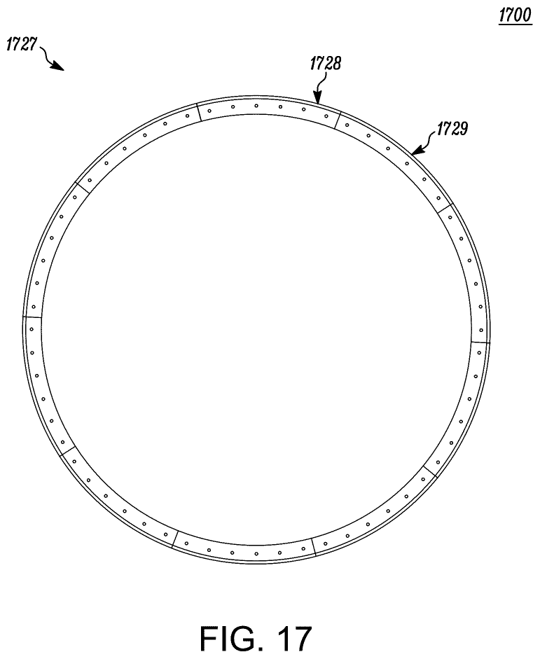

FIG. 17 is a diagram 1700 showing a top-down view of a complete containment system 1727 formed by arranging drip trays together. The containment system 1727 is composed of multiple segments, including a first drip tray segment 1728 and a second drip tray segment 1729, which connect to form a circular configuration. The first drip tray segment 1728 and the second drip tray segment 1729 are designed to interlock or align adjacent to create the complete containment system 1727. This ensures that the system can capture and contain grease or other liquids effectively when installed in a wind turbine or structure desiring material capture.

In other embodiments, the complete containment system 1727 could be designed to have a different shape or size to better fit different tower designs or to capture grease more efficiently. For instance, the complete containment system 1727 could be designed to have an oval, rectangular, or polygonal shape, depending on the shape of the structure to which it is to be attached. The size of the complete containment system 1727 could also be adjusted, either to make it larger and capture more grease or to make it smaller and easier to install and maintain.

In various embodiments, the first drip tray segment 1728 and the second drip tray segment 1729 could be designed to interlock or align in different ways, depending on the specific requirements of the structure to which the complete containment system 1727 is to be attached. The first drip tray segment 1728 and the second drip tray segment 1729 could also be designed to have different shapes or sizes to better fit the complete containment system 1727 or to optimize the containment of grease within the system.

In some aspects, the first drip tray segment 1728 and the second drip tray segment 1729 could be made from different materials, provided they retain the desired properties such as grease resistance and durability. The first drip tray segment 1728 and the second drip tray segment 1729 could also be designed to have different shapes or sizes to better fit the complete containment system 1727 or to optimize the containment of grease within the system.

In this embodiment, the containment system 1727 involves ten radially shaped drip tray segments connected end to end. In other embodiments, the containment system 1727 involves a different number of drip tray segments depending on the target structure.

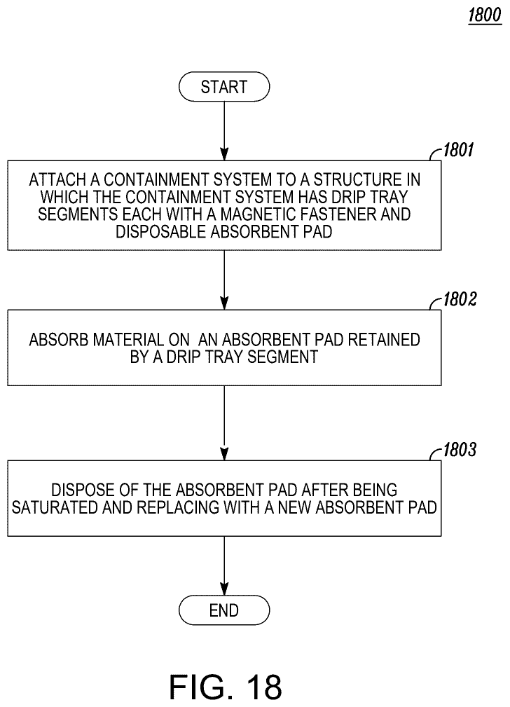

FIG. 18 is a diagram of a flowchart 1800 for installing and using a containment system, such as containment system 1727. The process begins with a containment system attachment step 1801. In the containment system attachment step 1801, a containment system comprising drip tray segments, each equipped with a magnetic fastener a disposable absorbent pad, such as magnetic fastener 1415 and disposable absorbent pad 1813, is attached to a structure. This structure could be a wind turbine, a building, or any other structure where grease or other liquid leakage is a concern. The magnetic fastener is attached to and magnetically connected to a metallic feature on the structure.

In the next step, a material absorption step 1802, material such as grease is absorbed by the absorbent pad retained by a drip tray segment. The absorbent pad is designed to absorb and contain the grease, preventing it from spreading and causing safety or cleanliness issues.

The process concludes with an absorbent pad disposal and replacement step 1803. This step involves the disposal of the saturated absorbent pad and its replacement with a new absorbent pad. The saturated absorbent pad can be easily removed from the drip tray and replaced with a new one, ensuring that the drip tray is ready to continue capturing and containing grease or other liquids.

In other embodiments, the procedures for installing and maintaining the product could be varied in several ways. For instance, the installation procedure could be simplified or made more complex, depending on the skills and abilities of the installers. The maintenance procedure could also be adjusted, either to make it easier and more efficient or to make it more thorough and effective. For example, in some cases, the absorbent pad could be replaced more or less frequently, depending on the amount of grease or other liquid being captured. In various embodiments, the containment system could be checked and maintained on a regular schedule, or it could be checked and maintained based on the amount of grease or other liquid observed in the drip tray.

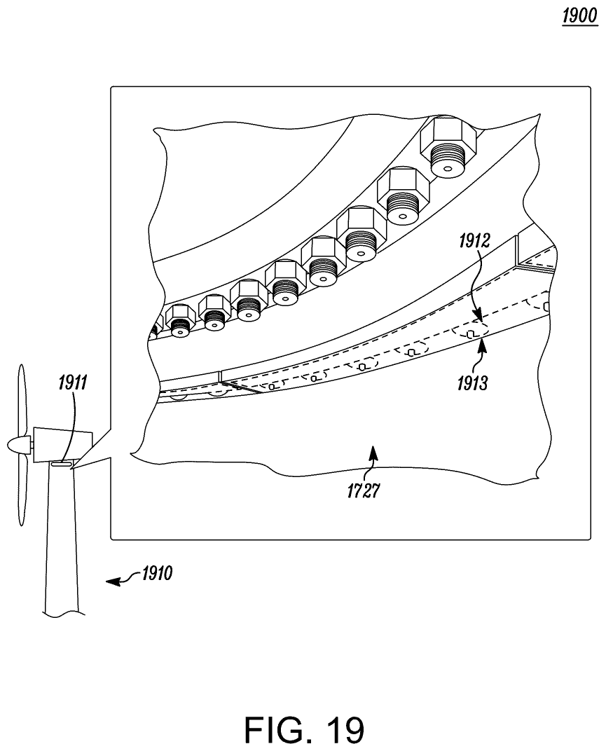

FIG. 19 is a diagram 1900 showing a perspective view of a containment system installed within a wind turbine structure 1910. The wind turbine structure 1910 is designed to house and support various components of a wind turbine, including a yaw bearing 1911. The yaw bearing 1911 is centrally positioned and connected to the wind turbine structure 1910, allowing the wind turbine to rotate or yaw in response to wind direction changes.

Multiple bolt ends 1912 are arranged in a circular pattern around the yaw bearing 1911. These bolt ends 1912 serve as attachment points for magnetic fasteners 1913 of the drip tray. The magnetic fasteners 1913 are designed to attach the drip tray to the corresponding part of the structure, specifically to the bolt ends 1912 of the yaw bearing system. This ensures secure placement and alignment of the containment system within the wind turbine structure 1910.

In various embodiments, the containment system can be installed within different types of wind turbine structures, depending on the specific requirements of the wind turbine. The containment system can also be designed to align with different patterns of bolt ends, depending on the design of the yaw bearing system.

In other embodiments, the containment system can be installed in different positions within the wind turbine structure, depending on the location of the yaw bearing and the pattern of bolt ends. The containment system can also be designed to capture and contain different types of liquids, not just grease, depending on the specific requirements of the wind turbine.

In some aspects, the containment system can be designed to be easily removed and replaced, allowing for regular maintenance and cleaning of the wind turbine structure. The containment system can also be designed to be easily inspected, allowing for regular checks of the condition of the yaw bearing and the bolt ends.

In other embodiments, the containment system can be designed to be adjustable, allowing for adjustments to be made to the position and alignment of the containment system within the wind turbine structure. This can be particularly useful in situations where the wind turbine structure or the yaw bearing system undergoes changes or modifications.

In various embodiments, the magnetic fasteners 1913 can attach to a bolt head, nut, or other ferromagnetic components already located on the wind turbine structure 1910 instead of a bolt end.

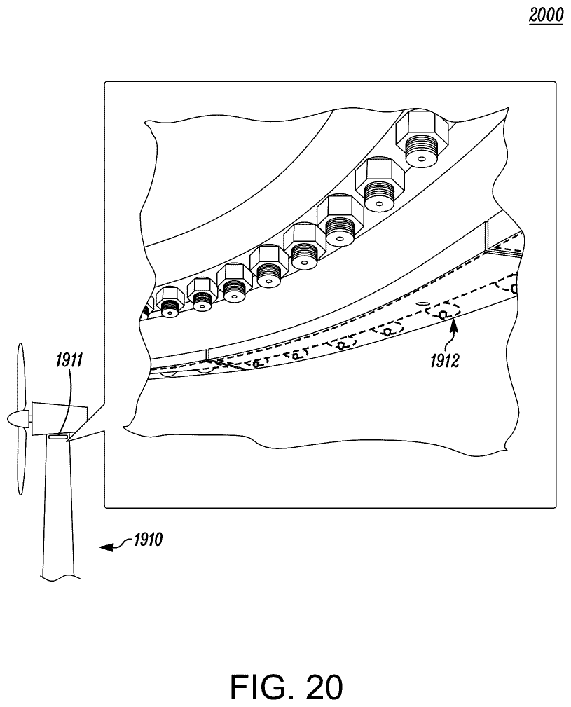

FIG. 20 is a diagram 2000 showing how material is captured along the tray drip segments of the containment system. In this example, the containment system is installed in the wind turbine structure 1910. The yaw bearing 1911 is shown attached to the wind turbine structure 1910. Multiple bolt ends 1912 are depicted as part of the containment system, indicating where the system is fastened to the structure. The containment system is positioned beneath the yaw bearing 1911 to intercept and collect material that might leak from the yaw bearing 1911, preventing it from contaminating the wind turbine structure 1910.

In some aspects, the containment system 1727 is designed to be installed within different types of wind turbine structures, depending on the specific requirements of the wind turbine. The containment system 1727 can also be designed to align with different patterns of bolt ends 1912, depending on the design of the yaw bearing system.

In other embodiments, the containment system 1727 can be installed in different positions within the wind turbine structure, depending on the location of the yaw bearing and the pattern of bolt ends. The containment system 1727 can also be designed to capture and contain different types of liquids, not just grease, depending on the specific requirements of the wind turbine.

In various embodiments, the containment system 1727 can be designed to be easily removed and replaced, allowing for regular maintenance and cleaning of the wind turbine structure. The containment system 1727 can also be designed to be easily inspected, allowing for regular checks of the condition of the yaw bearing and the bolt ends.

In other embodiments, the containment system 1727 can be designed to be adjustable, allowing for adjustments to be made to the position and alignment of the containment system 1727 within the wind turbine structure. This can be particularly useful in situations where the wind turbine structure or the yaw bearing system undergoes changes or modifications.

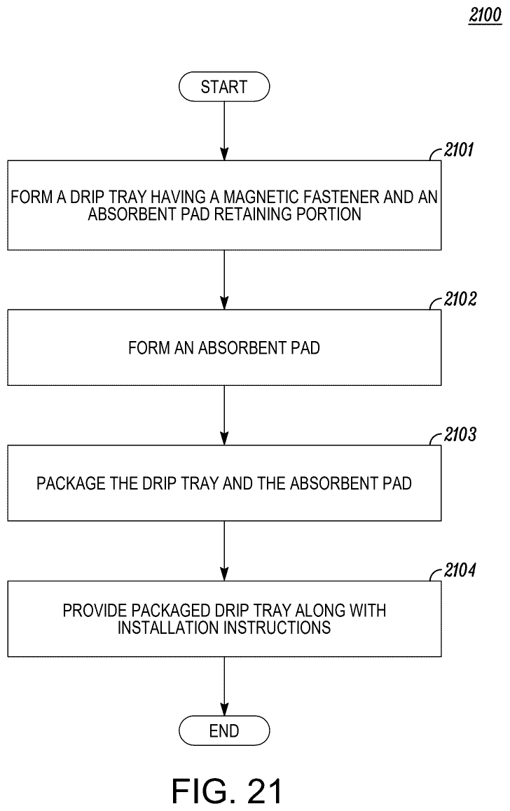

FIG. 21 is a flowchart of a method 2100 for forming and packaging a containment system. The method begins at a drip tray formation step 2101, where a drip tray having magnetic fasteners and an absorbent pad retaining portion is formed, such as drip tray 1410 with magnetic fasteners 1415, absorbent pad 1413, and retaining portion 1417 . . . . The formation of the drip tray involves shaping the drip tray to have a base, a first wall, a second wall, a third wall, and a fourth wall. The absorbent pad retaining portion is designed to hold an absorbent pad, and the magnetic fasteners are attached to the base 1 of the drip tray.

Next, the flowchart moves to an absorbent pad formation step 2102, where an absorbent pad is formed. The absorbent pad is designed to fit within the absorbent pad retaining portion of the drip tray. The absorbent pad is made from one or more layers of absorbent fiber materials capable of absorbing grease or other liquids.

Following this, the flowchart leads to a packaging step 2103, where the drip tray and the absorbent pad are packaged together. The packaging process involves placing the drip tray and the absorbent pad into a packaging material, such as a box or a bag, to protect them during transportation and storage.

Finally, the flowchart concludes with a provision step 2104, where the packaged drip tray, along with installation instructions, is provided. The provision step involves delivering the packaged drip tray and the installation instructions to a user or a location where the drip tray is to be installed. The installation instructions provide guidance on how to install the drip tray and how to replace the absorbent pad when it becomes saturated with grease or other liquids.

In other embodiments, the steps of method 2100 could be performed in a different order. For instance, the absorbent pad formation step 2102 could be performed before the drip tray formation step 2101. In various embodiments, additional steps could be included in the method 2100, such as a step of inspecting the drip tray and the absorbent pad before packaging them, or a step of testing the drip tray and the absorbent pad to ensure they meet quality standards.

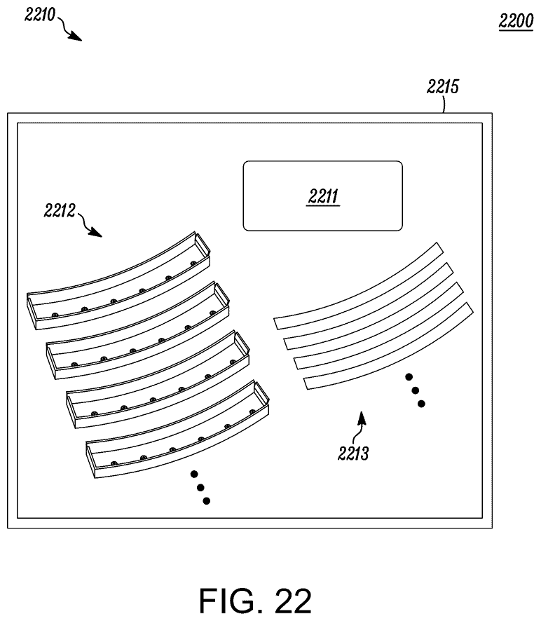

FIG. 22 is a diagram 2200 of a packaged containment system 2210. The packaged containment system 2210 contains a stack of drip trays 2212 and a stack of absorbent pads 2213. The stack of drip trays 2212 and the stack of absorbent pads 2213 are packaged together, providing a convenient and efficient way to transport and store the components of the containment system. Containment system instructions 2211 are also included in the packaged containment system box 2210. These instructions provide guidance on the use of the drip trays and absorbent pads, including how to install the drip trays, how to replace the absorbent pads, and how to maintain the containment system. The containment system packaging material 2215 ensures that the components of the containment system are securely packaged within the packaged containment system 2210, protecting them from damage during transportation and storage.

In other embodiments, the packaging and delivery of the product could be varied in several ways. For instance, the product could be sold in different quantities, such as packs of five or packs of twenty. This would allow customers to purchase the quantity that meets their specific requirements, whether they are installing a new containment system or replacing components of an existing system. The product could also be delivered in different ways, such as by mail or by a delivery service. This would provide flexibility in how the product is received, accommodating different customer preferences and logistical considerations. In various embodiments, the containment system instructions 2211 could be provided in different formats, such as printed instructions, digital instructions, or video instructions. This would cater to different learning styles and technological capabilities, ensuring that all users can effectively understand and follow the instructions.

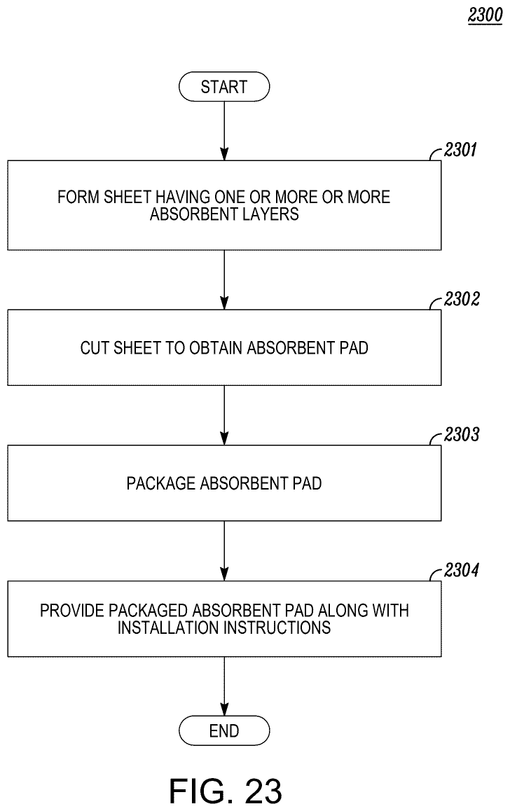

FIG. 23 is a flowchart of a method 2300 for forming and packaging absorbent pads for a drip tray system. The process begins with an absorbent layer formation step 2301, where a sheet with one or more absorbent layers is formed. This sheet could be formed from a variety of materials, such as absorbent fiber or sponge-like material, depending on the specific requirements of the drip tray system.

Next, the process moves to an absorbent pad cutting step 2302, where the sheet is cut to obtain the absorbent pad. The absorbent pad is designed to fit within the absorbent pad retaining portion of the drip tray. The shape and size of the absorbent pad can be adjusted to better fit the drip tray or to absorb grease more efficiently. For instance, the absorbent pad could be designed to have a rectangular, oval, or polygonal shape, depending on the shape of the drip tray.

Following this, an absorbent pad packaging step 2303 involves packaging the cut absorbent pad. The packaging process involves placing the absorbent pad into a packaging material, such as a box or a bag, to protect it during transportation and storage. The packaging material could be designed to securely hold the absorbent pad and prevent it from being damaged during transportation or storage.

Finally, a packaged pad distribution step 2304 provides the packaged absorbent pad along with installation instructions to the end user. The installation instructions provide guidance on how to install the absorbent pad in the drip tray and how to replace the absorbent pad when it becomes saturated with grease or other liquids. The installation instructions could be provided in different formats, such as printed instructions, digital instructions, or video instructions, to cater to different learning styles and technological capabilities.

In various embodiments, the steps of the method could be performed in a different order. For instance, the absorbent pad formation step could be performed before the drip tray formation step. Additional steps could also be included in the method, such as a step of inspecting the absorbent pad before packaging it, or a step of testing the absorbent pad to ensure it meets quality standards.

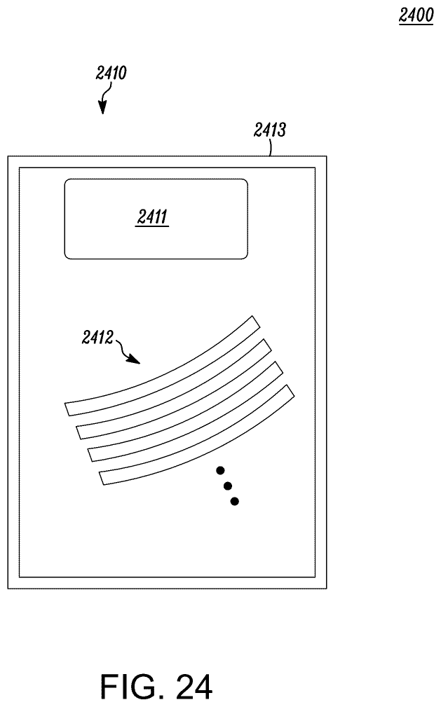

FIG. 24 is a diagram of a packaged absorbent pad system 2410. The packaging exterior 2413 encloses the absorbent pad package 2410, which contains a plurality of absorbent pads 2412 and an instruction sheet 2411. The instruction sheet 2411 provides guidance on the use of the absorbent pads 2412, which are designed to fit into a drip tray (not shown in the figure). The packaging exterior 2413 ensures that the absorbent pads 2412 and instruction sheet 2411 are kept together and protected until ready for use.

In various embodiments, the absorbent pad package 2410 could be designed to have a different shape or size to better fit the packaging exterior 2413 or to optimize the packaging of the absorbent pads 2412. The absorbent pad package 2410 could also be made from a different material, provided it retains the desired properties such as durability and resistance to damage during transportation or storage.

In other embodiments, the instruction sheet 2411 could be provided in different formats, such as printed instructions, digital instructions, or video instructions. This would cater to different learning styles and technological capabilities, ensuring that all users can effectively understand and follow the instructions.

In some aspects, the packaging exterior 2413 could be designed to have a different shape or size to better fit the absorbent pad package 2410 or to optimize the packaging of the absorbent pads 2412 and the instruction sheet 2411. The packaging exterior 2413 could also be made from a different material, provided it retains the desired properties such as durability and resistance to damage during transportation or storage.

In other embodiments, the absorbent pads 2412 could be made from a different type of absorbent fiber or even a sponge-like material, provided they retain the desired properties such as grease absorption and ease of replacement. The absorbent pads 2412 could also be designed to have a different shape or size to better fit the drip tray or to absorb grease more efficiently. For instance, the absorbent pads 2412 could be designed to have a rectangular, oval, or polygonal shape, depending on the shape of the drip tray. The size of the absorbent pads 2412 could also be adjusted, either to make them larger and absorb more grease or to make them smaller and easier to replace.

### NON-LIMITING EXAMPLES

Although specific examples of the subject matter have been disclosed, those having ordinary skill in the art will understand that changes can be made to the specific examples without departing from the spirit and scope of the disclosed subject matter. The scope of the disclosure is not to be restricted, therefore, to the specific examples, and it is intended that the appended claims cover any and all such applications, modifications, and examples within the scope of the present disclosure.

What is claimed is:

1. A yaw-bearing grease tray comprising:
an arcuate flat band portion with an inner arcuate sidewall, an outer arcuate sidewall, a first end wall, and a second end wall perpendicularly disposed on the arcuate flat band portion, with a ledge on the first end wall and a step at the second end wall, each of the ledge and the step are substantially parallel to the arcuate flat band portion; and
a plurality of magnets are disposed on the arcuate flat band portion.

2. The yaw-bearing grease tray of claim 1, wherein a first height of the inner arcuate sidewall is higher than a second height of the outer sidewall, and wherein the second height of the outer sidewall is equal to a third height of the first end wall and the second end wall.

3. The yaw-bearing grease tray of claim 2, wherein the step at the second end is formed by having a cutout in the inner arcuate sidewall, and the step is formed with a width and a height to create a complementary interlocking piece with a height and a width of a ledge of another yaw-bearing grease tray.

4. The yaw-bearing grease tray of claim 1, wherein the plurality of magnets is disposed approximately equidistance between each other on the arcuate flat band portion.

5. The yaw-bearing grease tray of claim 1, further comprises
a removable arcuate-shaped absorbent material sized to fit within the arcuate flat band portion to capture grease.

6. The yaw-bearing grease tray of claim 1, wherein the arcuate flat band portion, the inner arcuate sidewall, the outer arcuate sidewall, the first end wall, and the second end wall are formed from translucent material.

7. The yaw-bearing grease tray of claim 6, wherein the ledge and the step are formed from translucent material.

8. The yaw-bearing grease tray of claim 1, wherein the arcuate flat band portion, the inner arcuate sidewall, and the outer arcuate sidewall are formed as separate components and attached to the arcuate flat band portion using one of glue, adhesive, ultra-sonic welding, or a combination of both.

9. The yaw-bearing grease tray of claim 8, wherein the ledge and the step are formed as separate components and attached to the arcuate flat band portion using one of glue, adhesive, ultra-sonic welding, or a combination of both.

10. A yaw-bearing grease tray system comprising:
a first yaw-bearing grease tray formed with an arcuate flat band portion with an inner arcuate sidewall, an outer arcuate sidewall, a first end wall, and a second end wall perpendicular disposed on the arcuate flat band portion with a ledge on the first end wall and a step at the second end wall, each of the ledge and the step are substantially parallel to the arcuate flat band portion and a plurality of magnets are disposed on the arcuate flat band portion;
a second yaw-bearing grease tray formed with an arcuate flat band portion with an inner arcuate sidewall, an outer arcuate sidewall, a first end wall, and a second end wall perpendicular disposed on the arcuate flat band portion with a ledge and a step at the second end wall, each of the ledge and the step are substantially parallel to the arcuate flat band portion and a plurality of magnets are disposed on the arcuate flat band portion; and
wherein the ledge of the first yaw-bearing grease tray and the step of the second yaw-bearing grease tray form a complementary interlocking piece.

11. The yaw-bearing grease tray system of claim 10, wherein a height of the inner arcuate sidewall is higher than a height of the outer sidewall for each of the first yaw-bearing grease tray and the second yaw-bearing grease tray.

12. The yaw-bearing grease tray system of claim 11, wherein the step at the second end of the second yaw-bearing grease tray is formed by having a cutout in the inner arcuate sidewall, and the step is formed with a width and a height to create a complementary interlocking piece with a height and a width of a ledge of the first yaw-bearing grease tray.

13. The yaw-bearing grease tray system of claim 10, wherein the plurality of magnets on the first yaw-bearing grease tray and the second yaw-bearing grease tray is disposed approximately equidistance between each other on the arcuate flat band portion.

14. The yaw-bearing grease tray system of claim 10, further comprises
at least one removable arcuate-shaped absorbent material sized to fit within the arcuate flat band portion of the first yaw-bearing grease tray and the second yaw-bearing grease tray for capturing grease.

15. The yaw-bearing grease tray system of claim 10, wherein the arcuate flat band portion, the inner arcuate sidewall, and the outer arcuate sidewall of the first yaw-bearing grease tray and the second yaw-bearing grease tray are formed from translucent material.

16. The yaw-bearing grease tray system of claim 15, wherein the ledge and the step of both the first yaw-bearing grease tray and the second yaw-bearing grease tray are formed from translucent material.

17. The yaw-bearing grease tray system of claim 10, wherein the arcuate flat band portion, the inner arcuate sidewall, and the outer arcuate sidewall of the first yaw-bearing grease tray and the second yaw-bearing grease tray are formed as separate components and attached to the arcuate flat band portion using one of glue, adhesive, ultra-sonic welding, or a combination of both.

18. The yaw-bearing grease tray system of claim 17, wherein the ledge and the step of the first yaw-bearing grease tray and the second yaw-bearing grease tray are formed as separate components and attached to the arcuate flat band portion using one of glue, adhesive, ultra-sonic welding, or a combination of both.
